(19) United States
(12) Patent Application Publication
(10) Pub. No.: US 2010/0002264 A1
(43) Pub. Date: Jan. 7, 2010

(54) MEMORY READING AND WRITING APPARATUS AND IMAGE FORMING APPARATUS

(75) Inventor: Kenichi Ito, Osaka (JP)

Correspondence Address: IPUSA, P.L.L.C, 1054 31ST STREET, N.W., Suite 400, Washington, DC, 20007, US

(73) Assignee: RICOH COMPANY, LTD.

(21) Appl. No.: 12/494,556

(22) Filed: Jun. 30, 2009

(30) Foreign Application Priority Data
Jul. 7, 2008 (JP) 2008-177018
Jun. 25, 2009 (JP) 2009-150820

(51) Int. Cl. G06K 15/00; G06F 5/00

(52) U.S. Cl. 358/1.16; 710/52

(57) ABSTRACT

A method is disclosed by which B×n bits, including dummy bits and address data bits in the stated order are transmitted to a storage unit in series, B bits of transmission data is then transmitted to the storage unit in series, and the transmission data are written in the storage unit. The B×n bits including the dummy bits, a number of which dummy bits is smaller by one, address data bits and one dummy bit in the stated order are transmitted in series. A signal is given by a storage unit in response to the data transmitted to the storage unit, and a group of B bits of the signal is processed as data read from the storage unit after a last bit of a group of B bits of the signal indicates address reception completion.

### BACKGROUND OF THE INVENTION

1. Field of the Invention

The present invention relates to a memory reading and writing apparatus which writes data to a memory and reads data from the memory, an information medium (IC card), an I/O control apparatus, an image reading apparatus and an image forming apparatus each using the memory reading and writing apparatus. For example, the present invention may be used in an apparatus for reading data from and writing data to a storage unit which uses a data recording medium, and an I/O (input and output) control apparatus, a scanner, a printer, a copier, an image processing multi-function apparatus, a facsimile apparatus and so forth, each using the storage unit and the apparatus for reading data from and writing data to the storage unit.

2. Description of the Related Arts

Japanese Laid-Open Patent Application No. 9-69849 discloses a personal computer and a communication system using an asynchronous communication interface for a CPU having a synchronous communication interface. Japanese Laid-Open Patent Application No. 2002-149396 discloses in FIG. 8 a CPU which transmits and receives data based on a multiple-length operation instruction, and discloses in FIG. 10 an IC card provided with the CPU. Japanese Laid-Open Patent Application No. 2007-133085 discloses in FIG. 3 an operating and display board, an image processing engine controller, an image multi-function processing controller and an I/O controller each having a CPU. Japanese Laid-Open Patent Application No. 2008-107924 discloses in FIG. 2 an image processing engine controller which carries out data transmission and reception between a CPU, a plurality of memories and various I/F with the use of an ASIC (address decoder).

### SUMMARY OF THE INVENTION

An object of the present invention is to avoid bit disagreement.

According to the present invention, a reading and writing apparatus which writes data in a storage unit and reads data from the storage unit changes a disposition of dummy data in a serial bit arrangement of control data to be sent to the storage unit when reading data from the storage unit, from a disposition of dummy data in a serial bit arrangement of control data to be sent to the storage unit when writing data to the storage unit, so that the top of data read from the storage unit is stored at the top of a reception register of the reading and writing apparatus. In order to achieve the above-mentioned operation, the reading and writing apparatus according to the present invention has the following configuration. It is noted that, for the purpose of easy understanding, reference numerals of corresponding elements or corresponding matters depicted in the figures and will be described later are depicted in brackets, which are explanatory and exemplary only.

According to the present invention, a memory reading and writing apparatus (1) has a transmission register (109) and a reception register (110) each having a size of B (=8) bits, a transmission port (b), a reception port (a) and a synchronization clock signal output port (c). The number B corresponds to a number B of bits to be written in and read from one address of a storage unit (2). The storage unit (2) notifies the memory reading and writing apparatus (1) of address reception completion (A0 recognition bit “0”) when completing reception of address data (A9 through A0). The transmission port is used to transmit data, set in the transmission register, to the storage unit in series. The reception port is used to receive data transmitted from the storage unit in series, the received data being then stored in the reception register (109). The synchronization clock signal output port is used to output a synchronization clock signal (SYNC_CLK) used for transmitting data to the storage unit via the transmission port and for receiving data from the storage unit via the reception port. The memory reading and writing apparatus includes a control part (105). Under the control of the control part, the memory reading and writing apparatus transmits a serial arrangement of data to the storage unit. The serial arrangement of data includes dummy bits (DO7 through DO5, “0”), a start bit (DO4, “1”), control code bits (DO3, DO2, “C1”, “C0”) and address data bits (DO1, DO0, DO7 through DO0, “A9” through “A0”), in the stated order. The serial arrangement thus includes the number of bits, i.e., the number B (8)×integer n (2) (n being equal to or more than 1) (8×2=16). The memory reading and writing apparatus transmits the serial arrangement of data for each B bits from the top as a group. That is, after once storing in the transmission register, the memory reading and writing apparatus transmits data [NOTE: I deleted this clause because it seems redundant] via the transmission port to the storage unit together with the synchronization clock signal in series. Then, subsequently, B bits of transmission data (D7 through D0) are transmitted in series to the storage unit via the transmission port together with the synchronization clock signal after once being stored in the transmission register. Thus, the transmission data are written in the storage unit (FIGS. 4A, 4B, FIGS. 7A, 7B). After that, under control of the control part, the memory reading and writing apparatus transmits a serial arrangement of data including dummy bits (DO7, DO6, “0”), a start bit (DO5, “1”), control code bits (DO4, DO3, “C1”, “C2”), address data bits (DO2 through DO0, DO7 through DO1, “A9” through “A0”) and one dummy bit (DO0, “0”), in the stated order, as a total B×n bits, for each B bits from the top of the serial arrangement of data, to the storage unit via the transmission port together with the synchronization clock signal, after once storing in the transmission register in series. In response thereto, the storage unit provides a signal to the reception port of the memory reading and writing apparatus. The memory reading and writing apparatus receives the signal in synchronization with the synchronization clock signal and stores each group of B bits of the thus-received signal from the storage unit via the reception port, in the reception register. Then, when a bit at the last of the signal stored in the reception register corresponds to address reception completion (A0 recognition bit “0”), the memory reading and writing apparatus determines a group of B bits stored in the reception register after that as data read from the storage unit. Thus, the memory reading and writing apparatus reads data from the storage unit (FIGS. 5A, 5B and FIGS. 6A, 6B and 6C).

Other objects, features and advantages of the present invention will become more apparent from the following detailed description when read in conjunction with the accompanying drawings.

### BRIEF DESCRIPTION OF THE DRAWINGS

FIGS. 1A and 1B depict a longitudinal sectional view of a multi-function full-color copier equipped with a memory reading and writing apparatus in an embodiment;

FIG. 2 depicts a block diagram of a general configuration of an image processing system of the copier depicted in FIGS. 1A and 1B;

FIG. 3 depicts a block diagram of a general configuration of a CPU acting as a memory reading and writing apparatus in an embodiment, connection with a storage unit which the CPU accesses, and functions of data transmission and reception between the CPU and the storage unit;

FIGS. 4A and 4B depict a flowchart of control of a main control unit 105 in the memory reading and writing apparatus (i.e., CPU 511) in an embodiment for data writing to the storage unit (i.e., NV-RAM 512);

FIGS. 5A and 5B depict a flowchart of control of the main control unit 105 in the memory reading and writing apparatus (i.e., CPU 511) in an embodiment for data reading from the storage unit (i.e., NV-RAM 512);

FIGS. 6A, 6B and 6C depict a time chart for an operation sequence of the main control unit 105 in the memory reading and writing apparatus (i.e., CPU 511) in an embodiment for data reading from the storage unit (i.e., NV-RAM 512), FIG. 6A depicts the contents of first and second bytes of data stored in sequence in a transmission register 109 having a capacity of 1 byte; FIG. 6B depicts the contents of first, second and third bytes of data stored in sequence in a reception register 110 having a capacity of 1 byte; and FIG. 6C depicts bit sequences of transmission and reception data in serial transmission;

FIGS. 7A and 7B depict a time chart for an operation sequence of the main control unit 105 in the memory reading and writing apparatus (i.e., CPU 511) in an embodiment for data writing to the storage unit (i.e., NV-RAM 512), FIG. 7A depicts the contents of first, second and third bytes of data stored in sequence in the transmission register 109 having the capacity of 1 byte; and FIG. 7B depicts bit sequences of data transmitted in serial transmission; and

FIGS. 8A, 8B and 8C depict a time chart for an operation sequence of the main control unit 105 in the memory reading and writing apparatus (i.e., CPU 511) in an embodiment for data reading from the storage unit (i.e., NV-RAM 512), FIG. 8A depicts the contents of first and second bytes of data stored in sequence in the transmission register 109 having the capacity of 1 byte; FIG. 8B depicts the contents of first, second and third bytes of data stored in sequence in the reception register 110 having the capacity of 1 byte; and FIG. 8C depicts bit sequences of transmission and reception data in serial transmission.

### DESCRIPTION OF REFERENCE NUMERALS

10: OPERATING BOARD

120, 123, 131: DATA STORED IN TRANSMISSION REGISTER 109 AT FIRST TIME

121, 124, 132: DATA STORED IN TRANSMISSION REGISTER 109 AT SECOND TIME

122: DATA STORED IN TRANSMISSION REGISTER 109 AT THIRD TIME

126, 134: DATA STORED IN RECEPTION REGISTER 110 AT FIRST TIME

127, 135: DATA STORED IN RECEPTION REGISTER 110 AT SECOND TIME

128, 136: DATA STORED IN RECEPTION REGISTER 110 AT THIRD TIME

200: COLOR PRINTER

204: CHARGING ROLLER

205-1, 205-2r 205-3, 205-4: TRANSFER ROLLER

208: TRANSFER BELT

209 THROUGH 211: PAPER FEEDING TRAYS

212: REGISTRATION ROLLER PAIR

213: CONVEYANCE BELT

214: FIXING UNIT

252: OPTICAL WRITING UNIT

300: COLOR DOCUMENT SCANNER

320: AUTOMATIC DOCUMENT FEEDING UNIT

514: POWER SUPPLY UNIT

PC: PERSONAL COMPUTER

PBX: PRIVATE BRANCH EXCHANGE

PN: PUBLIC TELEPHONE NETWORK

### DETAILED DESCRIPTION OF THE PREFERRED EMBODIMENTS

In a central processing unit (i.e., CPU), a special peripheral for synchronous serial communication may be mounted, which can be operated with the use of a simple program. However, the above-mentioned peripheral may not be used depending on a communication specification of a storage unit to be used. If the peripheral cannot be used, a general-purpose port of the CPU is operated with the use of the program, a logic level is switched between “H” and “L”, and communication is carried out with a storage unit. More specifically, when a synchronization clock signal is output, a timer included in the CPU is started up, and an output of the general-purpose port is switched between “H” and “L” based on a timeout event of the timer, and thus, the synchronization clock signal is generated.

Further, serial data which are output from the CPU to the storage unit are configured by a plurality of bits, the data are read out from a register connected to a parallel internal bus, bit by bit, and the data which are arranged in parallel are output in synchronization with a rising edge or a decaying edge of the synchronization clock signal as a serial data sequence. That is, the data are output with P/S (parallel to serial) conversion.

As to an operation of reading from the storage unit, a serial data sequence read out from the storage unit in synchronization with a rising edge or a decaying edge of the synchronization clock signal are stored in a reading data storing register in synchronization with a rising edge or a decaying edge of the synchronization clock signal, bit by bit. That is, the data are stored with S/P (serial to parallel) conversion.

Thus, for each half period of the synchronization clock signal, setting of the timer, detecting of timeout of the timer, and changing a logic level of the general-purpose port (switching between “H” and “L”) are carried out, and reading data from the register, and storing data in the resister are carried out for each bit of data. Such complicated operations may be avoided when the above-mentioned special peripheral for a synchronous serial communication is used.

Thus, in a case where a CPU carries out control of data writing and reading for a rewritable storage unit with the use of serial communication, i.e., synchronous serial communication, the above-mentioned complicated operations may be avoided when the above-mentioned special peripheral for synchronous serial communication is used, which is mounted in the inside of the CPU. However, data transmission and reception is available only with a data width (i.e., the number of bits) of a special register provided for synchronization serial communication of the CPU.

In communication between a CPU and a storage unit, the CPU transmits, to the storage unit, as serial data, a start bit indicating a start of communication, a control code indicating the contents of control such as those of data writing and reading, and address data indicating a data storage area in the inside of the storage unit to be controlled. Then, the CPU transmits (writes) data to or receives (reads) data from the storage unit.

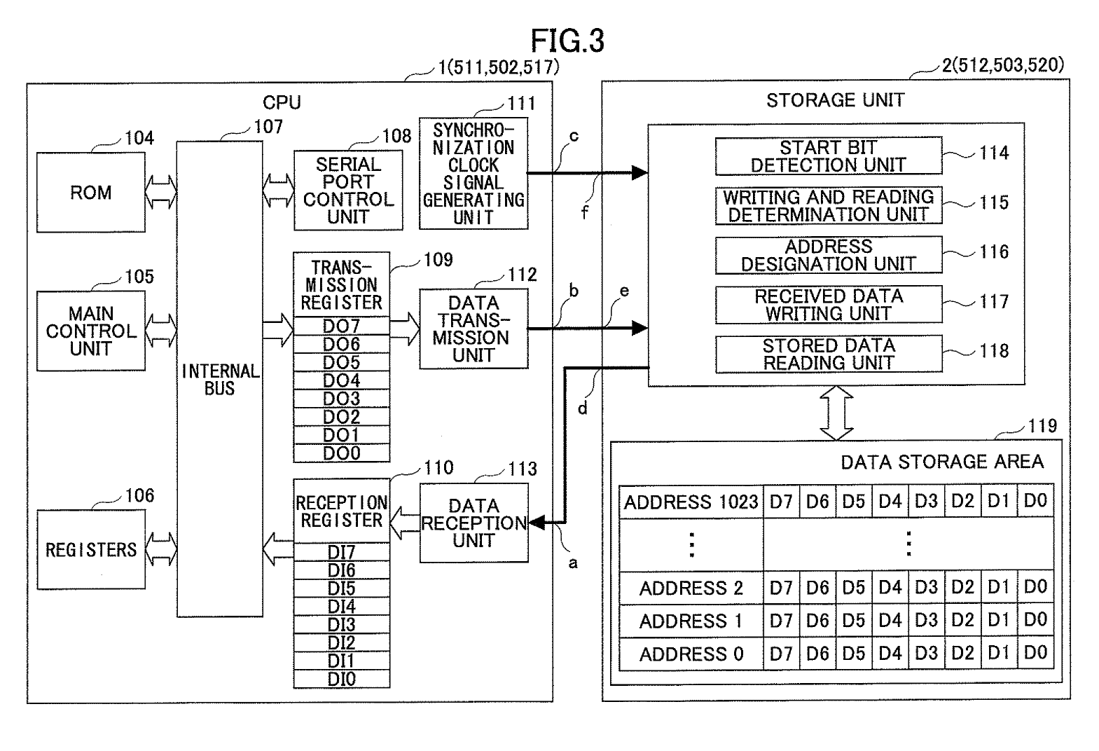

FIG. 3 depicts a general configuration of a CPU 1 and a storage unit 2 in an embodiment. The CPU 1 has a reception port “a” for receiving serial data, a transmission port “b” for transmitting serial data, and a synchronization clock signal output port “c” for outputting a synchronization clock signal SYNC_CLK which is used for data transmission and reception. A main control unit 105 of the CPU 1 reads a program code from a program memory ROM 104 to an internal bus 107. A serial port control unit 108 decodes the program code. According to the contents of control designated by the program code, the serial port control unit 108 controls an operation of storing transmission data of the internal bus 107 in a transmission register 109 of 8 bits (1 byte), i.e., DO7 through DO0, in parallel, and an operation of outputting the transmission data from the transmission register in series. Further, the serial port control unit 108 controls a synchronization clock signal generating unit 111, a data transmission unit 112 and a data reception unit 113, and controls an operation of storing received data in a reception register 110 of 8 bits (1 byte), i.e., DI7 through DI0, in series, and an operation of outputting the received data to the internal bus 107 in parallel.

When storing data in the storage unit 2, the main control unit 105 of the CPU 105 uses the serial port control unit 108 to write in the transmission register 109, bit by bit, 16 bits (2 bytes) of control data, address data and 8 bits (1 byte) of transmission data (i.e., storing data) to be transmitted to the storage unit 2 from the internal bus 107. Each time when finishing the writing, the main control unit 105 transfers the written data to the transmission unit 112, and reads the data (including the control data and the storing data) from the transmission register 109 in series in synchronization with the synchronization clock signal generated by the synchronization clock signal generating unit 111, and the data transmission unit 112 outputs the data (including the control data and the storing data) to the storage unit 2 in series. When reading data from the storage unit 2, the main control unit 105 outputs 16 bits (2 bytes) of control data and address data, the same as in the above-mentioned case of data storing, and stores, in a reception register 110 in synchronization with the synchronization clock signal, 1 byte of stored data (i.e., data read from the storage unit) which the storage unit 2 has sent to the reception port “a” in response to the 16 bits of control data and address data. The 1 byte of data read from the storage unit is then transferred to another internal register 106 in the CPU 1, or to the outside of the CPU 1, via the internal bus 107.

The storage unit 2 has a reception terminal “e” for receiving data which has been output in series by the CPU 1, a transmission terminal “d” for transmitting stored data in series, and a synchronization clock signal receiving terminal “f” for receiving the synchronization clock signal used for transmitting or receiving the serial data. The storage unit 2 further has a start bit detection unit 114 detecting a start bit transmitted by the CPU 1, a writing and reading control unit 115 determining whether a data writing instruction or a data reading instruction has been given, a data storage area 119 having 1014 addresses (i.e., addresses 0 through 1023) and 8 bits (1 byte) for each address to store data to be written thereto and read therefrom, an address designation unit 116 for designating an address of the data storage area 119, a received data writing unit 117 and a stored data reading unit 118.

The storage unit 2 takes data received from the CPU 1 and input to the reception terminal “e” in synchronization with the synchronization clock signal input to the synchronization clock signal receiving terminal “f”. Then, after detecting the start bit with the start bit detection unit 114, the storage unit 2 determines with the writing and reading determining unit 115 whether to write given data in the data storage area 119 or to read data from the data storage area 119. After the determination, the storage unit 2 designates, with the address designation unit 116, an address to access in the data storage area 119. When writing given data to the data storage area 119, the received data writing unit 117 is used to store received 1 byte of transmission data D7 through D0 at an address designated by the received address data bits A9 through A0 of the data storage area 119. When reading data from the data storage area 119, the stored data reading unit 118 is used to read 1 byte of data D7 through D0 from the data storage area 119, an address designated by address data bits A9 through A0, and the storage unit 2 transmits the read data D7 through D0 to the CPU 1 from the transmission terminal “d”.

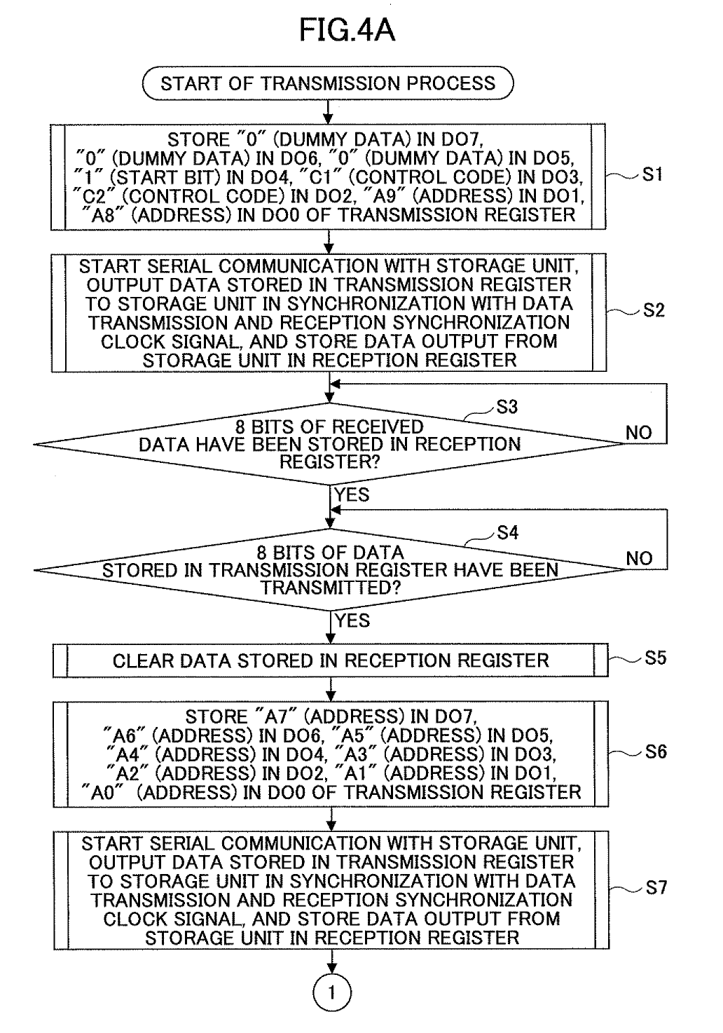

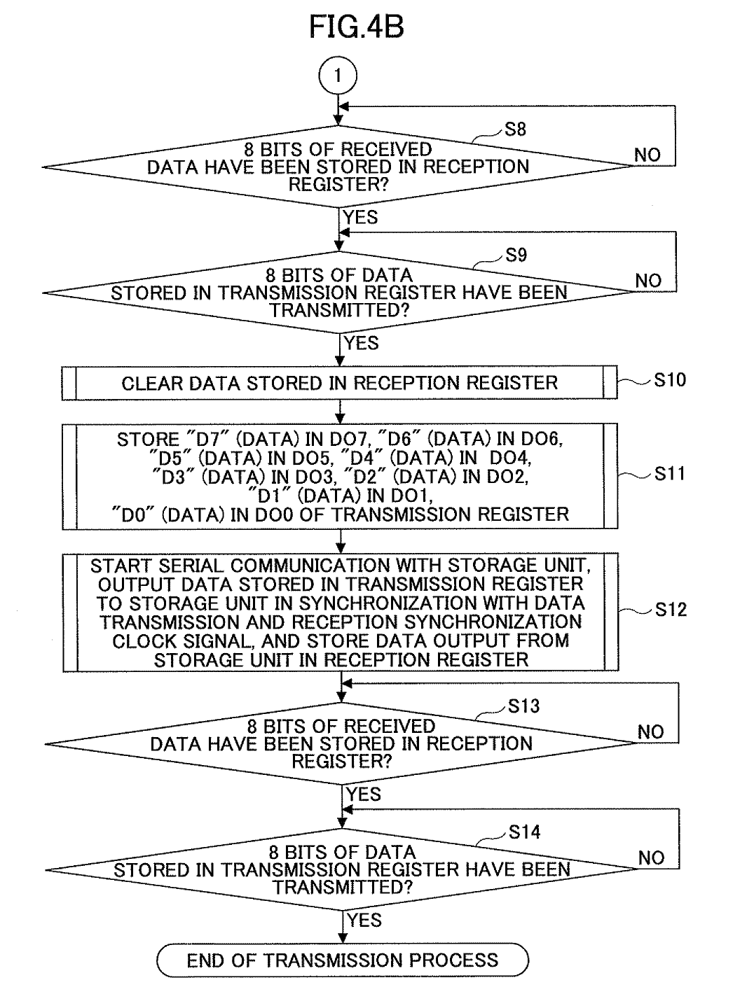

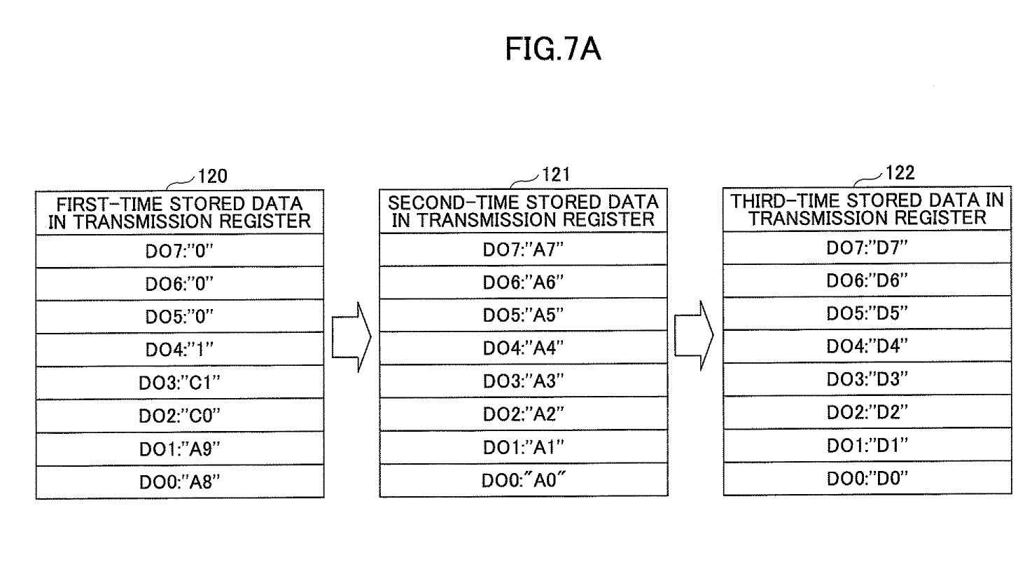

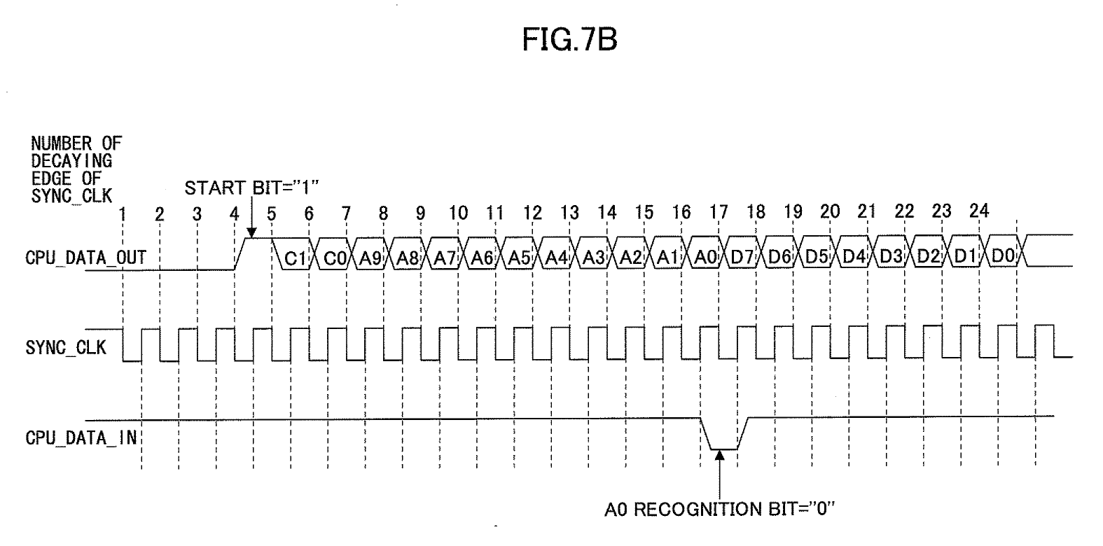

FIG. 4 depicts an operation flowchart for an operation of the main control unit 105 of the CPU 1 to transmit data and stores the data in the storage unit 2. FIG. 7A depicts 3 bytes of data written in the transmission register 109 in parallel and read from the transmission registers 109 in series for each byte in sequence during data transmission. FIG. 7B depicts transmission timing of the 3 bytes of data from the CPU 1 to the storage unit 2.

With reference to FIGS. 4A and 4B, and FIGS. 7A and 7B, data transmission from the CPU 1 to the storage unit 2 in an embodiment will now be described.

The main control unit 103 of the CPU 1 stores first 1 byte of data 120 in the transmission register 109 as depicted in FIG. 7A in step S1 of FIG. 4A. That is, in a bit storage position DO7, “0” is stored. In a bit storage position DO6, “0” is stored. In a bit storage position DO5 “0” is stored. In a bit storage position DO4, “1” is stored. In a bit storage position DO3, “C1” is stored. In a bit storage position DO2, “C0” is stored. In a bit storage position DO1, “A9” is stored. In a bit storage position DO0, “A8” is stored.

There, each “0” stored in DO7 through DO5 corresponds to a dummy bit. “1” stored in DO4 corresponds to a start bit. C1, C0 stored in DO3, DO2, respectively, correspond to control code bits. A9, A8 stored in DO1, DO0, respectively, correspond to more significant 2 bits of an address in the data storage area 119 having total 10 bits. In step S2 and S4 of FIG. 4A, the first 1 byte of data stored in the transmission register 109 in step S2 is then output first to the storage unit 2 as a CPU_DATA_OUT signal in synchronization with each decaying edge of the synchronization clock signal SYNC_CLK, as depicted in FIG. 7B, at the top and middle.

It is noted that, during transmitting data to the storage unit 2, as depicted in FIG. 7B, the bottom, “1” is sent from the storage unit 2 as a CPU_DATA_IN signal, and in steps S2, S3 and S5 of FIG. 4A, the “1” is stored in the reception register 110, and then, the “1” is cleared from the reception register 110. The same operation is carried out in steps S7, S8 and S10 and steps S12 and S13.

Next, in step S6 of FIG. 4A, the main control unit 105 stores a second 1 byte of data 121 in the transmission register 109 as depicted in FIG. 7A. That is, in a bit storage position DO7, “A7” is stored. In the bit storage position DO6, “A6” is stored. In the bit storage position DO5, “A5” is stored. In the bit storage position DO4, “A4” is stored. In the bit storage position DO3, “A3” is stored. In the bit storage position DO2, “A2” is stored. In the bit storage position DO1, “A1” is stored. In the bit storage position DO0, “A0” is stored. There, the above-mentioned A7 through A0 correspond to the less significant 8 bits of the address in the data storage area 119 having a total of 10 bits. In step S7 and S9 of FIGS. 4A and 4B, the second 1 byte of data stored in the transmission register 109 in step S6 is then output second to the storage unit 2 as a CPU_DATA_OUT signal in synchronization with each decaying edge of the synchronization clock signal SYNC_CLK, as depicted in FIG. 7B, at the top and middle. As depicted in FIG. 7B, at the bottom, “1” is sent from the storage unit 2 as a CPU_DATA_IN signal, and in steps S7, S8 and S10 of FIGS. 4A and 4B, the “1” is stored in the reception register 110, and then, is cleared.

When receiving A0 which is the least significant bit included in the first 1 byte data first transmitted from the CPU 1, the storage unit 2 outputs an A0 recognition bit “0” which indicates a completion of reception of A0, i.e., a completion of reception of the control data and the address data, to the CPU 1 as a CPU_DATA_IN signal in synchronization with a rising edge subsequent to a time when A0 is output from the CPU 1.

After thus transmitting the second 1 byte data, the main control 105 stores a third 1 byte of data 122 in the transmission register 109 in step S11 as depicted in FIG. 7A. That is, in a bit storage position DO7, “D7” is stored. In the bit storage position DO6, “D6” is stored. In the bit storage position DO5, “D5” is stored. In the bit storage position DO4, “D4” is stored. In the bit storage position DO3, “D3” is stored. In the bit storage position DO2, “D2” is stored. In the bit storage position DO1, “D1” is stored. In the bit storage position DO0, “D0” is stored. There, the above-mentioned D7 through D0 correspond to 1 byte of transmission data (i.e., data which is to be actually written in the storage unit 2). In step S12 and S14 of FIG. 4B, the third 1 byte of data stored in the transmission register 109 in step S11 is then output third to the storage unit 2 as a CPU_DATA_OUT signal in synchronization with each decaying edge of the synchronization clock signal SYNC_CLK, as depicted in FIG. 7B, at the top and middle. In step S12 and S13 of FIG. 4B, data received from the storage unit 2 is stored in the reception register 110. The storage unit 2 stores the above-mentioned transmission data D7 through D0 at the address in the data storage area 119 designated by the address data bits A9 through A0 included in the first and second bytes of data. This means that the CPU 1 can write 1 byte of data at any address of the data storage area 119 of the storage unit 2 with one time of data transmission (i.e., sequential transmission of the first, second and third bytes of data). That is, by thus inserting the three dummy bits “0” prior to the start bit, which are pseudo data and thus are irrelevant to control of the storage unit 2, in the serial data to be transmitted to the storage unit 2, the data serially transmitted can be made of integer bytes of data, and also, the transmission data D7 through D0 can be made in byte units.

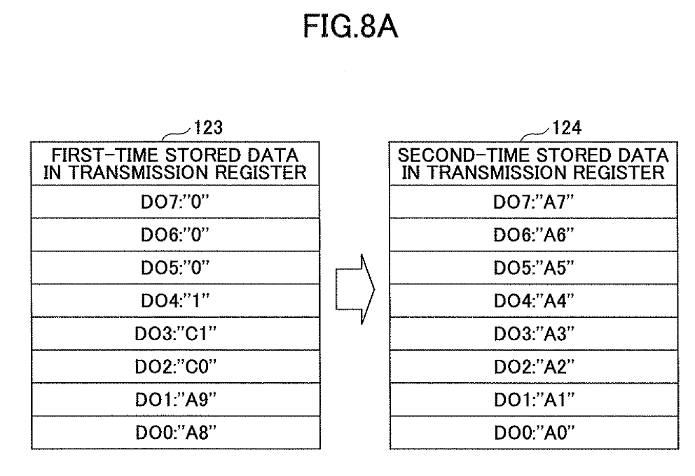

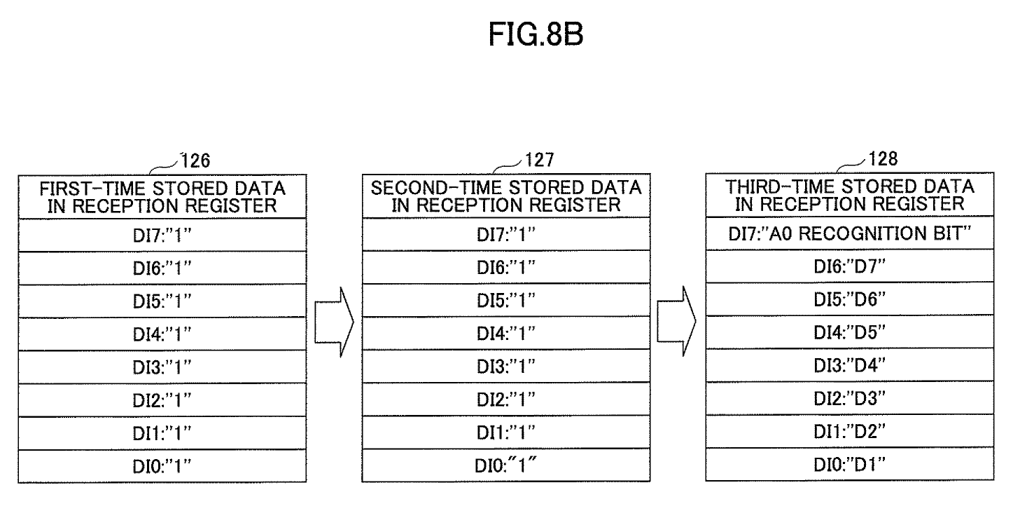

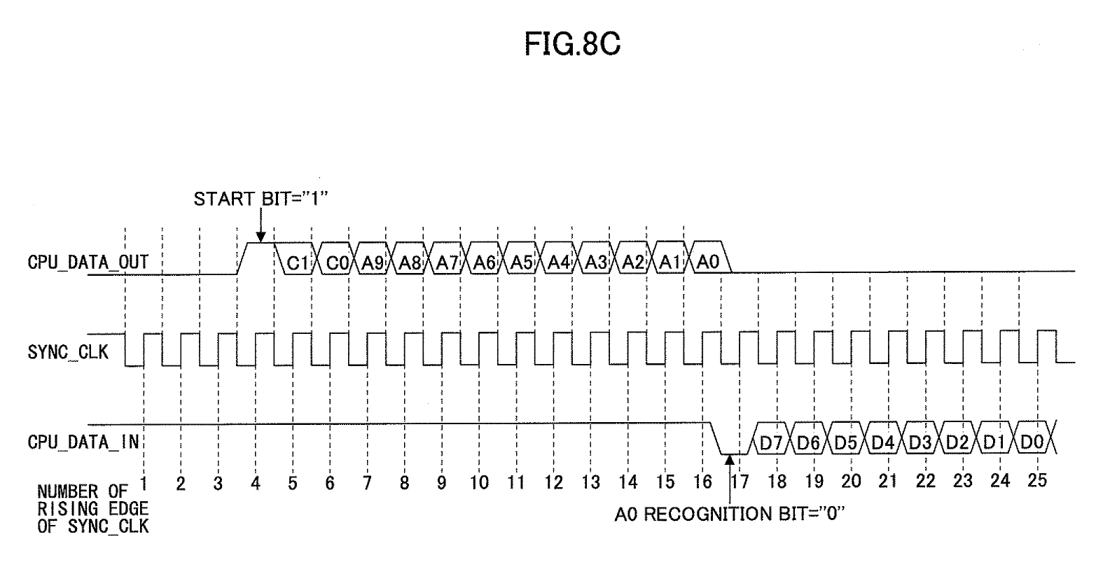

An operation of the CPU 1 reading data from the storage unit 2 in one example will now be described with reference to FIGS. 8A, 8B and 8C.

FIG. 8A depicts two bytes of control data 123 and 124 which the CPU 1 transmits to the storage unit 2 for reading data from the storage unit 2. FIG. 8B depicts states of the reception register 110 in which data read from the storage unit 2 and transmitted in series by the storage unit 2 in response to the above-mentioned two bytes of control data. FIG. 8C depicts transmission and reception timing in the CPU 1 for the two bytes of control data from the CPU 1 to the storage unit 2, an A0 recognition bit “0” and the above-mentioned data (D7 through D0) read from the storage unit 2 and transmitted in series by the storage unit 2 in response to the two bytes of control data.

In this case, the two bytes of control data 123 and 124 depicted in FIG. 8A have the same configuration as that of the control data 120 and 121 depicted in FIG. 7A used when the CPU 1 writes data to the storage unit 2, except that the contents of the control code bits C1, C2 are different therebetween. That is, the first 1 byte 123 first transmitted to the storage unit 2 by the CPU 1 includes 3 bits of dummy data, 1 start bit, 2 control code bits and more significant 2 bits of address data, and the second 1 byte 124 second transmitted includes less significant 8 bits of the address data.

The CPU 1 outputs the synchronization clock signal SYNC_CLK as depicted in FIG. 8C, middle, and in synchronization with a first decaying edge of the synchronization clock signal, the CPU 1 stores in the reception register 110 data transmitted as a CPU_DATA_IN signal by the storage unit 2 to the reception port “a”. The storage unit 2 outputs “1” to the CPU at any time until receiving the dummy bits, start bit, control code bits and address data, and then, receiving the last address data bit A0. That is, each of all the bits stored in the reception register 110 are “1”, until the first 1 byte 126 (first 8 bits of serial received data) and the second 1 byte 127 (ninth through sixteenth bits of the serial received data) from the storage unit 2 are stored in the reception register 110 in sequence as depicted in FIG. 8B.

As depicted in FIG. 8C, bottom, the storage unit 2 outputs an A0 recognition bit “0”, in synchronization with the seventeenth rising edge of SYNC_CLK, and after that, outputs stored data at the designated address of the data storage area 119. At this timer as depicted in FIG. 8B, the above-mentioned A0 recognition bit “0” is stored as the top bit of the third 1 byte 128. That is, the 8 bits of data which have been thus read and output from the storage unit 2 do not completely correspond, in a one-to-one manner, to the data stored at a time in the reception register 110. That is, the 8 bits of data included in the third 1 byte 128 include 7 bits of the 8 bits of data which have been thus read and output from the storage unit 2, i.e., D7 through D1, and do not include the last bit D0, as depicted in FIG. 8B. Thus, bit disagreement occurs. In this case, the CPU 1 should extracts the second through eighth bits of data D7 through D1 of the third 1 byte stored in the reception register 110, and then, the first bit of data D0 of a fourth 1 byte which will be stored in the reception register 110 next timer for sending to the internal bus 107 as a byte of data D7 through D0.

Thus, in the example described above with reference to FIGS. 8A, 8B and 8C, the CPU 1 carries out operation on the once stored data, and thus, a program for reading data from the storage unit 2 may become complicated. As described above, when reading data from the storage unit 2, the same number of bits of dummy data is inserted, as that of the dummy data inserted when writing data to the storage unit 2. In this case, bit disagreement occurs as mentioned above. In order to cancel the above-mentioned bit disagreement, the CPU 1 needs to carry out additional data processing on the two bytes of data received from the storage unit 2 and stored in the reception register 110 two times in sequence. Therefore, even if the above-mentioned special peripheral for synchronous serial communication is used, it may not be possible to simplify a necessary program.

In the embodiment, the above-mentioned problem occurring in the example described above with reference to FIGS. 8A, 8B and 8C is solved and it is possible to avoid bit disagreement. In the embodiment, when the memory reading and writing apparatus (1) writes data in the storage unit (2), control data used have B×n bits (i.e., 8×2=16). Also, a reading and writing data unit of a transmission register (109) and the storage unit is B bits. Thus, writing data of B bits, which are the same as the above-mentioned reading and writing data unit, are written in the storage unit through n (=2) times of data transmission of the control data and a subsequent one time of data transmission for B bits of the writing data or transmission data as described above with reference to FIGS. 4A, 4B, FIGS. 7A, 7B.

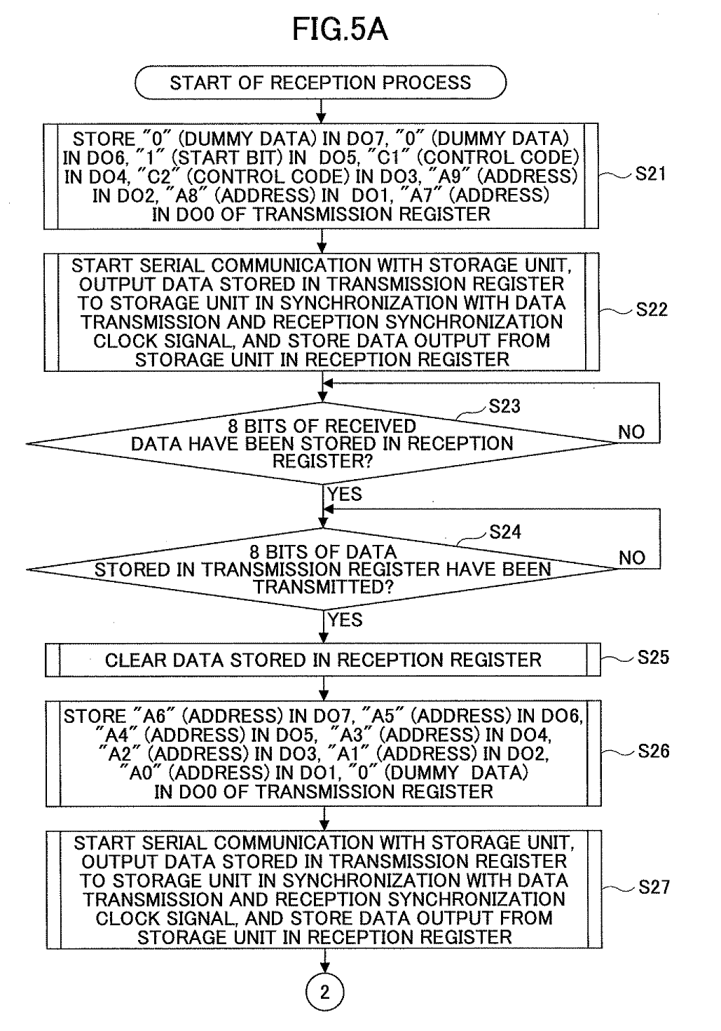

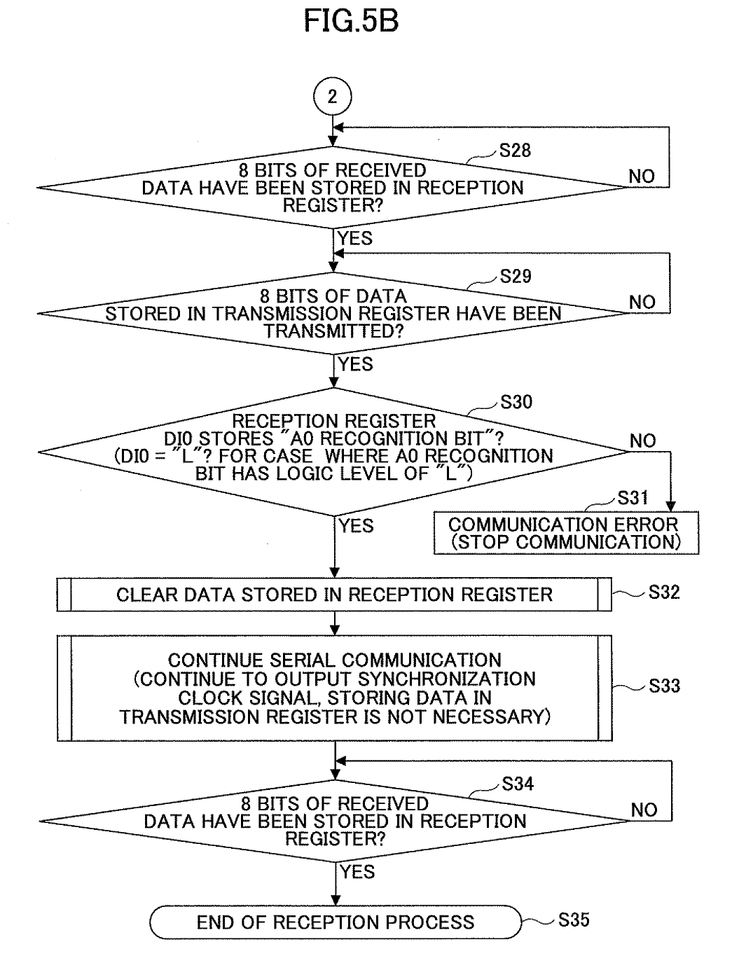

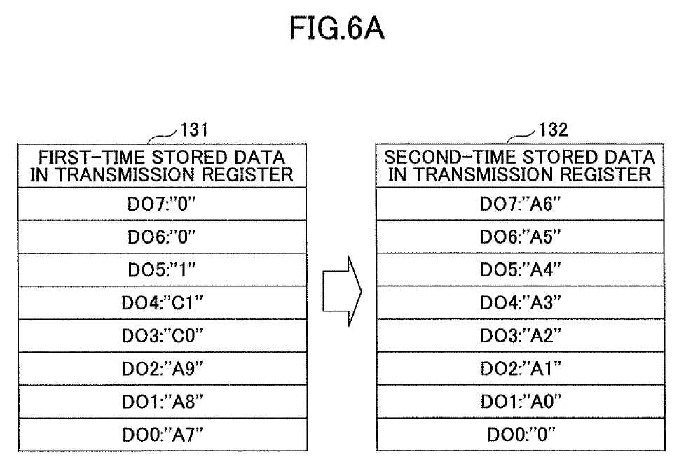

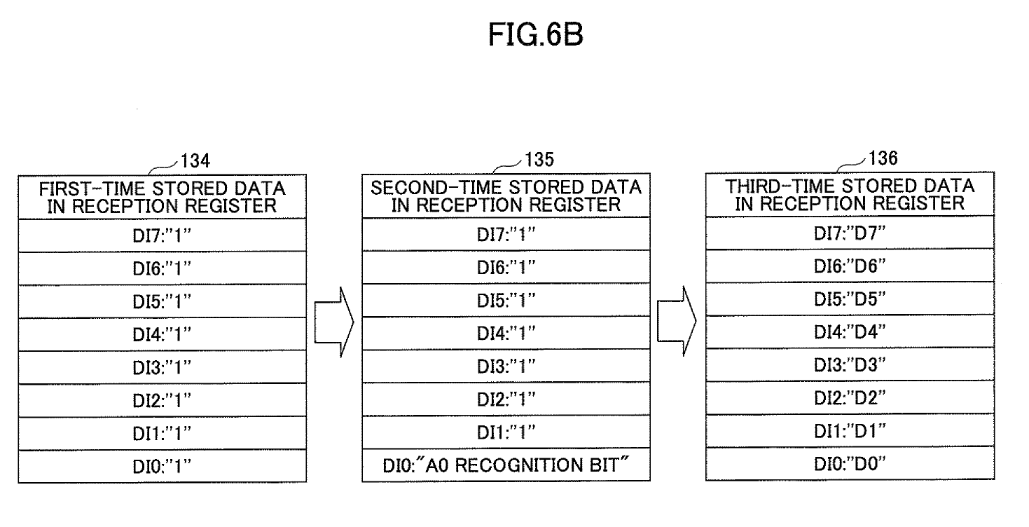

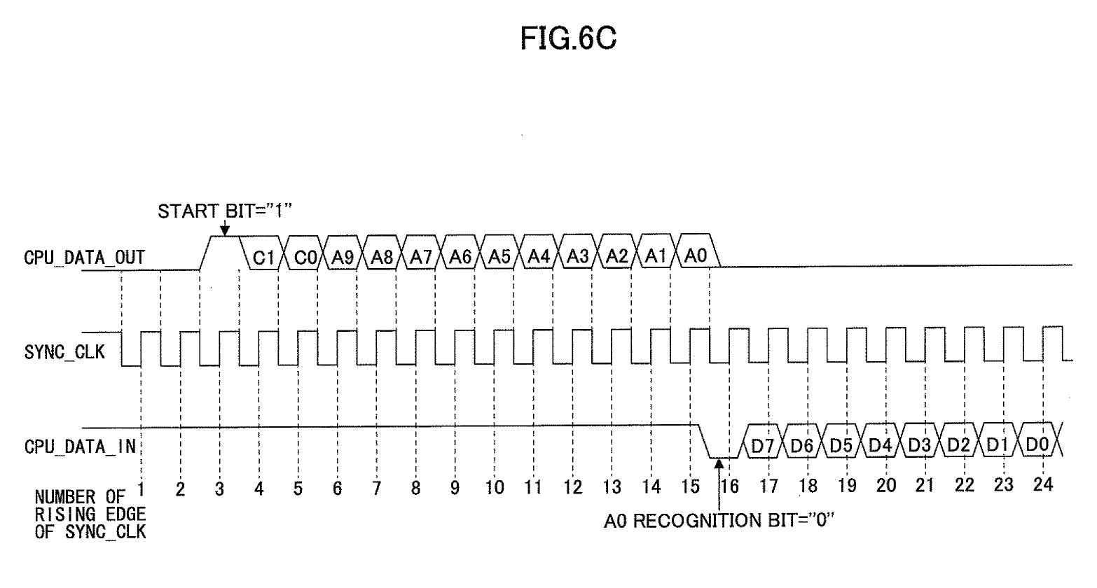

When the memory reading and writing apparatus (1) reads data from the storage unit (2) (as will be described later with reference to FIGS. 5A, 5B, FIGS. 6A, 6B and 6C), control data sent to the storage unit from the memory reading and writing apparatus (1) has B×n (8×2=16) bits, the same as in the case of writing data in the storage unit (2), and data is sent n times, with B bits each time. However, in the last B bits of the control data, the last bit is a dummy bit, bits prior to the last bit are address data bits, and the bit immediately prior to the dummy bit is A0 which is the last bit of the address data bits (132 in FIG. 6A). Thereby, a bit indicating address reception completion (A0 recognition bit “0”), which the storage unit sends when recognizing the A0, is disposed as the last bit of a B bit unit of data stored in the reception register (110) (135 in FIG. 6B). As a result, a subsequent B bit unit of data stored in the reception register (110) agrees with a B bit unit of data which has been read from the storage unit (2) (136 in FIG. 6B). Accordingly, B bits of data of one address, read and output by the storage unit (2), completely corresponds to data stored in the reception register (110) at one time, in a one-to-one manner. That is, bit disagreement is avoided.

As a result, it is not necessary to carry out data processing which may be otherwise required as mentioned above with reference to FIG. 8B, 128, when B bits of data read from the storage unit at one time are stored in the reception register two times separately, to create B bits of data for one address. Thus, in the embodiment, it is possible to simplify a memory reading and writing program by omitting a program required for the above-mentioned data processing described above with reference to FIGS. 8A, 8B and 8C. As a result, it is possible reduce a total program size, and to reduce a total cost of the memory reading and writing apparatus.

That is, according to the embodiment, a memory reading and writing apparatus (1) has the transmission register (109) and the reception register (110) each having the size of B (=8) bits, the transmission port (b), the reception port (a), and the synchronization clock signal output port (c). The number B corresponds to the number B of bits to be written in and read from one address of the storage unit (2). The storage unit (2) notifies the memory reading and writing apparatus (1) of address reception completion (A0 recognition bit “0”) when completing reception of address data (A9 through A0). The transmission port (b) is used to transmit data set in the transmission register (109), to the storage unit (2) in series. The reception port (a) is used to receive data transmitted from the storage unit (2) in series, the received data being then stored in the reception register (110). The synchronization clock signal output port (c) is used to output a synchronization clock signal (SYNC_CLK) used for transmitting data to the storage unit (2) via the transmission port (b) and for receiving data from the storage unit (2) via the reception port (a). The memory reading and writing apparatus (1) includes a control part (105). Under the control of the control part (105), the memory reading and writing apparatus (1) transmits a serial arrangement of data to the storage unit (2). The serial arrangement of data includes dummy bits (DO7 through DO5, “0”), a start bit (904, “1”), control code bits (903, 902, “C1”, “C0”) and address data bits (DO1, DO0, DO7 through DO0, “A9” through “A0”), in the stated order. The serial arrangement thus includes the number of bits, i.e., the number B (8)×integer n (2) (n being equal to or more than 1) (8×2=16). The memory reading and writing apparatus (1) transmits the serial arrangement of data for each B bits from the top as a group, after once storing in the transmission register (109). Thus, the data stored in the transmission register (109) is transmitted via the transmission port (b) to the storage unit (2) together with the synchronization clock signal in series. Then, subsequently, B bits of transmission data (D7 through D0) is transmitted in series to storage unit (2) via the transmission port (b) together with the synchronization clock signal after once storing in the transmission register (109). Thus, the transmission data is written in the storage unit (FIGS. 4A, 4B, FIGS. 7A, 7B).

After that, under control of the control part (105), the memory reading and writing apparatus (1) transmits a serial arrangement of data including dummy bits (DO7, DO6, “0”), the number of the dummy bits being smaller by one than the number of the above-mentioned dummy bits (DO7 through DO5, “0”), a start bit (DO5, “1”), control code bits (DO4, DO3, “C1”, “C2”), address data bits (DO2 through DO0, DO7 through DO1, “A9” through “A0”) and one dummy bit (DO0, “0”), in the stated order, as total B×n bits, for each B bits from the top of the serial arrangement of data, to the storage unit (2) via the transmission port (b), after once storing in the transmission register (109), in series together with the synchronization clock signal. In response thereto, the storage unit (2) provides a signal to the reception port (a) of the memory reading and writing apparatus (1). The memory reading and writing apparatus (1) receives the signal in synchronization with the synchronization clock signal and stores each group of B bits of the thus-received signal from the storage unit (2) via the reception port (a), in the reception register (110). Then, when a bit at the last of the signal stored in the reception register (110) corresponds to address reception completion (A0 recognition bit “0”), the memory reading and writing apparatus (1) determines a group of B bits stored in the reception register (110) after that as data read from the storage unit (2). Thus, the memory reading and writing apparatus (1) reads data from the storage unit (2) (FIGS. 5A, 5B and FIGS. 6A, 6B and 6C). As a result, it is not necessary to carry out data processing which may be otherwise required, when the read B bits of data is stored in the reception register two times separately (as described above with reference to FIG. 8B, 128), to create B bits of data for one address.

That is, according to the embodiment, the memory reading and writing apparatus (1) has the transmission register (109) and the reception register (110) each having a size of the number (=8) of bits, the transmission port (b), the reception port (a), and the synchronization clock signal output port (c). The number corresponds to one byte to be written in and read from one address of the storage unit (2). The storage unit (2) notifies the memory reading and writing apparatus (1) of address reception completion (A0 recognition bit “0”) when completing reception of address data (A9 through A0). The transmission port (b) is used to transmit data set in the transmission register (109), to the storage unit (2) in series. The reception port (a) is used to receive data transmitted from the storage unit (2) in series, the received data being then stored in the reception register (109). The synchronization clock signal output port (c) is used to output the synchronization clock signal (SYNC_CLK) used for transmitting data to the storage unit (2) via the transmission port (b) and for receiving data from the storage unit (2) via the reception port (a). The memory reading and writing apparatus (1) includes the control part (105). Under the control of the control part (105), the memory reading and writing apparatus (1) transmits a serial arrangement of data to the storage unit (2). The serial arrangement of data includes the dummy bits (DO7 through DO5, “0”), the start bit (DO4, “1”), the control code bits (DO3, DO2, “C1”, “C0”) and the address data bits (DO1, DO0, DO7 through DO0, “A9” through “A0”), in the stated order. The serial arrangement thus includes 2 bytes (i.e., 16 bits) of data. The memory reading and writing apparatus (1) transmits the serial arrangement of data for each one byte of the bit group from the top as a group, by once storing in the transmission register (109), and then, transmitting the data thus stored in the transmission register (109) via the transmission port (b) to the storage unit (2) together with the synchronization clock signal in series. Then, subsequently, a byte of transmission data (D7 through D0) is transmitted in series to the storage unit (2) via the transmission port (b) together with the synchronization clock signal after once being stored in the transmission register (109). Thus, the transmission data is written in the storage unit (2) (FIGS. 4A, 4B, FIGS. 7A, 7B).

After that, under the control of the control part (105), the memory reading and writing apparatus (1) transmits a serial arrangement of data including the dummy bits (DO7, DO6, “0”), the number of the dummy bits being smaller by one than the number of the above-mentioned dummy bits (DO7 through DO5, “0”), the start bit (DO5, “1”), the control code bits (DO4, DO3, “C1”, “C2”), the address data bits (DO2 through DO0, DO7 through DO1, “A9” through “A0”) and the one dummy bit (DO0, “0”), in the stated order, as a total of 2 bytes, for each byte from the top of the serial arrangement of data, to the storage unit (2) via the transmission port after once storing the transmission register (109), in series together with the synchronization clock signal. In response thereto, the storage unit (2) provides a signal to the reception port (a) of the memory reading and writing apparatus (1). The memory reading and writing apparatus (1) receives the signal in synchronization with the synchronization clock signal and stores each group of one byte of the thus—received signal from the storage unit (2) via the reception port (a), in the reception register (110). Then, when a bit at the last of the signal stored in the reception register (110) corresponds to address reception completion (A0 recognition bit “0”), the memory reading and writing apparatus (1) determines a group of one byte stored in the reception register after that as data read from the storage unit (2). Thus, the memory reading and writing apparatus (1) reads data from the storage unit (2) (FIGS. 5A, 5B and FIGS. 6A, 6B and 6C). As a result, it is not necessary to carry out data processing which may be otherwise required when B bits of data read from the storage unit (2) is stored in the reception register (110) two times separately (see FIG. 8B, 128), to create a byte of data for one address.

Thus, in the embodiment, the above-mentioned data transmitted by the memory reading and writing apparatus (1) has a width of 8 bits. A serial arrangement of data transmitted immediately before transmitting data to be written to the storage unit (2) includes the three dummy bits (DO7 through DO5, “0”), the one start bit (DO4, “1”), the two control code bits (DO3, DO2, “C1”, “C0”), and the ten address data bits (DO1, DO0, DO7 through DO6, “A9” through “A0”) in the stated order. The above-mentioned data read from the storage unit has a width of 8 bits, and a serial arrangement to be transmitted by the memory reading and writing apparatus (1) for reading data from the storage unit (2) includes the two dummy bits (DO7, DO6, “0”), the one start bit (DO5, “1”), the two control code bits (DO4, DO3, “C1”, “C0”), the ten address data bits (DO2 through DO0, DO7 through DO1, “A9” through “A0”), and the one dummy bit (DO0, “0”) in the stated order.

Further, in an embodiment, an image forming part (200) which forms an image represented by image data on paper includes an engine control part (510) which carries out control of image formation of the image forming part (200), and an I/O control part (513) which carries out control of input and output of sensors and loads of the image forming part (200). The engine control part (510) includes a program memory (ROM 510-3), a NV-RAM (512) acting as the above-mentioned storage unit (2) and notifying a CPU (511) of address reception completion when completing reception of address data, and the CPU (511) acting as the above-mentioned memory reading and writing apparatus (1) and carrying out data reading and writing from/to the NV-RAM (512), and controlling image formation in the image forming part (200) by providing control instructions to the I/O control part (513) according to programs and data stored in the program memory (ROM 510-3) and the NV-RAM (512).

Further, in an embodiment, the image forming part (200) which forms an image represented by image data on paper includes the engine control part (510) which carries out control of image formation of the image forming part (200), and a system controller (501) which gives instructions for image forming conditions designated by a user to the engine control part (510), and inputs and outputs image data to/from the engine control part (510). The system controller (501) includes a program memory (ROM 501-2), a NV-RAM (503) acting as the above-mentioned storage unit (2) and notifying a CPU (502) of address reception completion when completing reception of address data, and the CPU (502) acting as the above-mentioned memory reading and writing apparatus (1) an carrying out data reading and writing from/to the NV-RAM (503), and transmitting and receiving image data to/from the engine control part (510) according to image processing instructions externally given via communication, and programs and data stored in the program memory (ROM 501-2) and the NV-RAM (503).

Further, in an embodiment, the image forming part (200) which forms an image represented by image data on paper includes the engine control part (510) which carries out control of image formation of the image forming part (200), and the I/O control part (513) which carries out control of input and output of sensors and loads of the image forming part (200). The I/O control part (513) includes a program memory (ROM 518), a NV-RAM (520), acting as the above-mentioned storage unit (2) which notifies a CPU (517) of address reception completion when completing reception of address data, and the CPU (517) acting as the above-mentioned memory reading and writing apparatus (1), carrying out data reading and writing from/to the NV-RAM (520), and carrying out the above-mentioned control of input and output according to control instructions given by the engine control part (510), and programs and data stored in the program memory (ROM 518) and the NV-RAM (520)

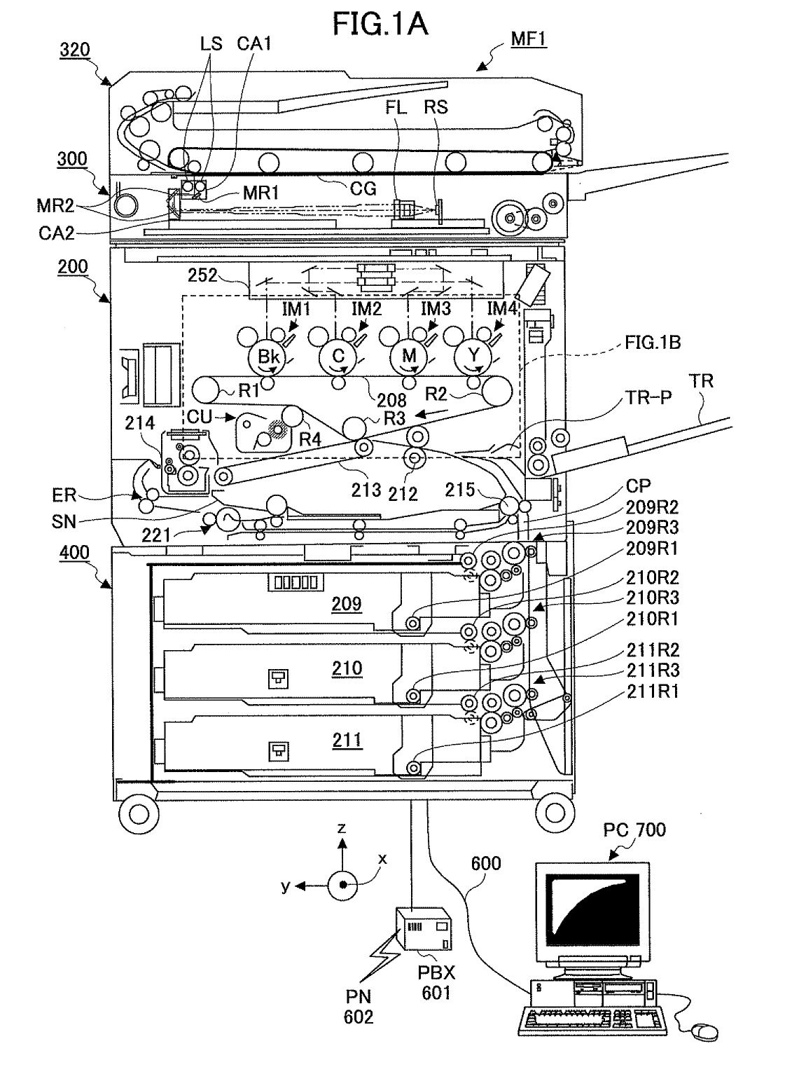

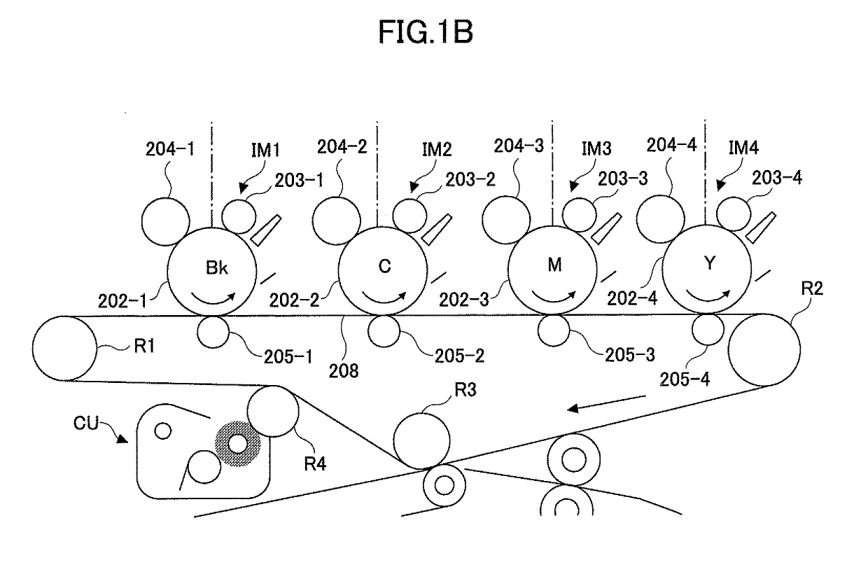

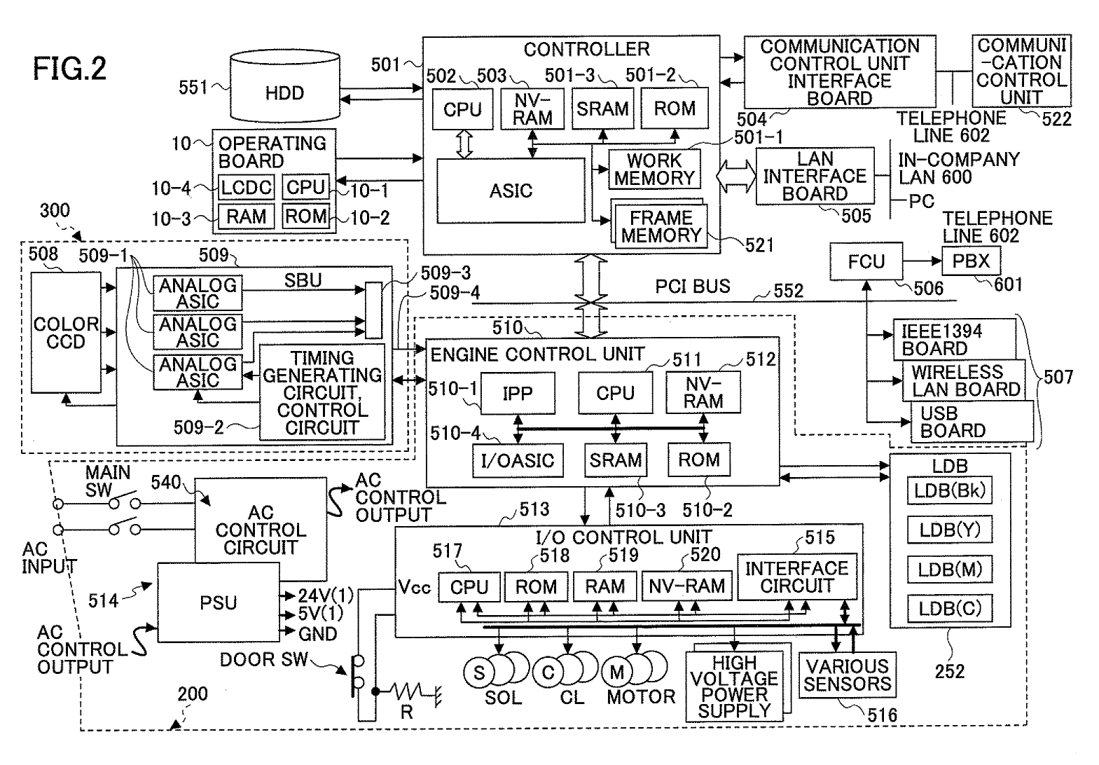

FIGS. 1A and 1B depict an appearance of a multi-function full-color digital copier MF1 equipped with a memory reading and writing apparatus in an embodiment. It is noted that FIG. 1B depicts a magnified view of a part in FIG. 1A defined by a rectangle drawn by a broken line indicated as “FIG. 1B”. The full-color copier MF1 includes an automatic document feeding unit (ADF) 310, an operating board 10 (see FIG. 2), a color scanner 300, a color printer 200, and a paper feeding bank 400. To a system controller 501 (see FIG. 2) included in the full-color copier MF1, a LAN (Local Area Network) 600 is connected, to which a personal computer 700 is connected. Further, a facsimile controller 506 (see FIG. 2) in the full-color copier MF1 is used to carry out facsimile communication via a private branch exchange 601 and a public telephone network 602.

The printer 200 includes a transfer unit, and the transfer unit includes a transfer belt 208 which is an endless belt. The transfer belt 208 is wound on three support rollers R1 through R3 and one tension roller R4, and is rotated counterclockwise. Near the tension roller R4, a transfer member cleaning unit CU is provided to remove residual toner from the transfer belt 208.

On the transfer belt 208 between the support rollers R1 and R2, image forming units IM1, IM2, IM3 and IM4 for respective colors, i.e., Bk (black), C (cyan), M (magenta) and Y (yellow), respectively, are provided. For the image forming units IM1 through IM4, respective transfer rollers 205-1, 205-2, 205-3 and 205-4 are provided via the transfer belt 208, and are opposite to respective photosensitive drums 202-1, 202-2, 202-3 and 202-4, respectively. Above the image forming units IM1 through IM4, an optical writing unit 252 is provided for irradiating laser light for image formation to the photosensitive drums 202-1 through 202-4. The photosensitive drums 202-1 through 202-4 are uniformly charged by charging rollers 203-1 through 203-4, respectively, and laser light which is modulated by image signals is irradiated to the charged surfaces of the photosensitive drums 202-1 through 202-4. Thereby, respective electrostatic latent images are formed on the photosensitive drums 202-1 through 202-4, are then developed by developers 204-1, 204-2, 204-3 and 204-4, respectively, and thus, respective toner images are formed on the photosensitive drums 202-1 through 202-4. The toner images are then transferred to the transfer belt 208 in a mutually overlaying manner to create a toner image.

Below the transfer belt 209, a conveyance belt 213 is provided. The conveyance belt 213 transfers the toner image on the transfer belt 208 to paper, i.e., a sheet (or a transfer paper sheet). The paper to which the toner image is transferred is sent to a fixing unit 214 by the conveyance belt 213. Below the conveyance belt 213 and the fixing unit 214, a both side drive unit 221 is provided, which is a sheet reversing unit which feeds paper, to an obverse side of which paper a toner image is transferred immediately before, for recording a toner image also on a reverse side of the paper.

When a start switch on the operating board 10 is pressed, an original is conveyed to a contact glass CG of a scanner 300 when the original is placed on an automatic document feeding unit (ADF) 320. Then a first carriage CA1 and a second carriage CA2 in the scanner 300 are driven for reading the original. When no original is placed on the automatic document feeding unit (ADF) 320, the first and second carriages CA1 and CA2 are driven immediately for reading an original manually placed on the contact glass CG. Then, light is emitted to the contact glass CG from light sources LS on the first carriage CA1, reflected light from a surface of the original is then reflected by a first mirror MR1 on the first carriage CA1, then is reflected by second mirrors MR2 on the second carriage CA2, then passes through a focusing lens FL, and thus, forms an image on a COD which is a reading sensor RS. Based on image signals obtained from the reading sensor RS, recording data of respective colors, i.e., Bk, C, M and Y, are generated.

Further, when the start switch is pressed, driving of the transfer belt 208 is started, and also, image forming preparation is started in each of the image forming units IM1 through IM4. Then, image forming sequences for the respective colors are started, exposure laser light modulated by recording data of the respective colors is used to irradiate the photosensitive drums 202-1 through 202-4 of the respective colors. Thus, through the image forming processes of the respective colors, the toner images of the respective colors are transferred to the transfer belt 208 in a mutually overlaying manner for the single toner image. To the transfer belt 208, voltages for transferring toner are applied by the transfer rollers 205-1 through 205-4. When a leading edge of the toner image on the transfer belt 208 reaches the conveyance belt 213, paper is fed to the transfer belt 208 from a registration roller pair 212, i.e., feeding rollers, in such a timing that a leading edge of the paper reaches the conveyance belt 213 at the same time. Thereby, the toner image on the transfer belt 208 is transferred to the paper. The paper to which the toner image is thus transferred is then fed to the fixing unit 214, which then fixes the toner image to the paper.

It is noted that, the above-mentioned paper is fed to the conveyance belt 213 through the following process. That is, one of paper feeding rollers 209R1, 210R1 and 211R1 immediately above respective paper feeding trays (which may also be referred to as paper feeding stages or paper feeding cassettes) 209, 210, 211 of a paper feeding bank 400 is selectively driven. Thus, a sheet of paper is taken from the corresponding one of the multistage type paper feeding trays 209, 210 and 211, a corresponding one of separating rollers 209R2, 210R2 and 211R2 feeds the sheet of paper which then passes through a corresponding set of vertically arranged conveyance rollers 209R3, 210R3 and 211R3. Thus, the paper is conveyed upward for a conveyance path CP in the printer 200, the conveyance roller 215 conveys the paper to the registration roller pair 212, and the leading edge of the paper is stopped at the registration roller pair 212. Then, at the above-mentioned timing, the registration roller pair 212 and the conveyance roller 215 are driven, and the paper is fed to the conveyance belt 213. It is also possible that paper is inserted manually to a manual inserting tray TR provided at the right end. When a user inserts paper to the manual inserting tray TR, a paper feeding roller TR-R in a manual inserting unit is driven, a sheet of the paper is then separated from the manual inserting tray TR for a manual inserting paper feeding path TR-P. Consequently, in the same as the above mentioned manner, the paper is stopped at the registration roller pair 212.

The paper having undergone the toner image fixing process in the fixing unit 214 is then stacked on a paper ejecting tray (not depicted) after being guided by a switching claw SN to a paper ejecting roller ER. Alternatively, the switching claw SN may guide the paper to the both side drive unit 221, in which the paper is reversed, for the toner image transfer position again. Then, a reverse side of the paper has a toner image transferred thereto, and then, the paper is ejected to the paper ejecting tray via the paper ejecting roller ER. Residual toner on the transfer belt 208 after the toner image transfer process is removed by the transfer member cleaning unit CU, and is prepared for a subsequent image formation process.

FIG. 2 depicts a system configuration of an electric equipment system in the multi-function copier (or image forming apparatus) MF1 depicted in FIGS. 1A and 1B. The electric equipment system includes a system controller 501 which carries out control of the entirety of the image forming apparatus MF1, an operating board 10 connected to the system controller 501, an HDD (Hard Disk Drive) 511 storing image data, a communication control unit interface board 504 carrying out external communication with the use of an analog communication line, and a LAN interface board 505. The electric equipment system further includes a facsimile control unit 506, and an IEEE 1394 board, a radio LAN board and a USB board 507, each of which is connected to a general-purpose PCI bus 552. The electric equipment system further includes an engine control unit 510 connected to the PCI bus 552, an I/O board 513 which controls I/O of the image forming apparatus MF1, a scanner board (i.e., SBU or Sensor Board Unit) 511 which is used to read a copy original (image), and the optical writing unit 252 which emits light representing image data to the photosensitive drums 202-1 through 202-4.

The reading unit 300 which is used to optically read an original scans an original with the use of the light sources LS, and focus reflected light to the CCD 508 (i.e., the above-mentioned reading sensor RS). The CCD 508 carries out photoelectric conversion on a thus-focused original image and generates R, G and B image signals.

When trouble occurs in the image forming apparatus MF1, the communication control unit interface board 504 reports the trouble to an external remote diagnosis unit (not depicted) immediately, so that a service staff can recognize the contents and situation of the trouble, and carry out an appropriate repairing operation on the image forming apparatus MF1. Other than the above, the communication control unit interface board 504 may also be used to transmit a state indicating how the image forming apparatus MF1 is used, for example.

The CCD 508 depicted in FIG. 2 is a 3-line color CCD, and generates the R, G and B image signals of an even pixel channel and an odd pixel channel, to an analog ASIC (Application Specific IC) 509-1 of the SBU board 509. The SBU board 509 includes the analog ASIC 509-1, and a circuit 509-2 which generates driving timing signals for the CCD 508 and the analog ASIC 509-1. An output of the COD 508 undergoes a sampling and holding operation by a sample hold circuit (not depicted) in the analog ASIC 509-1, then undergoes analog to digital conversion into R, G and B image data which then undergo shading correction. Then, the image data are sent to an image processing processor (i.e., IPP) 510-1 via an output IF unit 509-3 and an image data bus 509-4.

The IPP 510-1 is a programmable arithmetic processing unit, and carries out a separating and generating process (i.e., determining whether given image data is of a character area or a photograph area, i.e., image area separation), a background removal process, a scanner gamma transform process, a filtering process, a color correction process, a size change process, an image modification process, a printer gamma transform process, and a tone processing process. The image data sent to the IPP 510-1 from the SBU 509 then undergo correction for signal degradation (i.e., signal degradation concerning the scanner) which may occur in an optical system or from quantization into a digital signal. After that, the image signal is written in frame memories 521.

The system controller 501 includes a CPU 502, a ROM 501-2 storing a program which the CPU 502 executes to control the system controller 501, a SRAM 501-3 used by the CPU 502 as a working memory, a NV-RAM 503 which includes a lithium battery, acts as a backup memory for the SRAM 501-3, and further includes a clock, an ASIC 501-4 which carries out system control of the system controller 501, and control of peripheries such as the frame memories 521 and FIFO (not depicted), and an interface circuit (not depicted).

The system controller 501 has a plurality of functions, i.e., a scanner application, a facsimile application, a printer application and a copy application, and controls the entirety of the system of the image forming apparatus MF1. The system controller 501 interprets an input given via the operating board 10, and displays on the operating board 10 settings and states of the system.

Many units are connected to the PCI bus 552, and, in the PCI bus 552, an image data bus and a control command bus are included for transferring image data and control commands, respectively, in a time division manner.

The communication control unit interface board 504 provides a communication interface between a communication control unit 522 and the system controller 501. Communication with the system controller 501 is carried out in a full-duplex asynchronous serial transmission method. The communication control unit interface board 504 is connected with the communication control unit 522 in a multi-dropped connection method according to RS-485 interface standard. The communication control unit interface board 504 is used to communicate with a remote management system (not depicted).

The LAN interface board 505 is connected to an in-company LAN 600, and provides a communication interface between the system controller 501 and the in-company LAN 600. The LAN interface board 500 includes a PHY chip (i.e., a physical layer chip, not depicted). Between the LAN interface board 505 and the system controller 501, a standard communication interface with the use of a PHY chip I/F (i.e., interface) and an I2C bus I/F (not depicted) is provided. The LAN interface board 505 is used to communicate with an external apparatus (not depicted).

The HDD 551 is used as an application database which stores application programs of the system of the image forming apparatus MF1, and apparatus driving information for the printer 200 and image forming process parts/units, and an image data base which stores image data of images read from an original, image data of images to be written to the photosensitive bodies 202-1 through 202-4, and document data. The HDD 551 is connected to the system controller 501 via an interface according to ATA/ATAPI-4 for both a physical interface and an electrical interface.

The operating board 10 includes a CPU 10-1, a ROM 10-2, a RAM 10-3, an ASIC (LCDC) 10-4 which controls a liquid crystal touch panel (not depicted) and controls key input. A control program is written in the ROM 10-2 which is used to control reading of key input, and display on the liquid crystal touch panel. The RAM 10-3 is used as a working memory by the CPU 10-1. The operating board 10 carries out control for a user to input system settings with the use of the liquid crystal touch panel and control for displaying to the user the contents of system settings, states of the system or such, by communicating with the system controller 501.

Image data (or writing signals) for the respective colors i.e., Bk, C, M and Y output by the working memory 501-1 of the system controller 501 is input to the optical writing unit 252. The optical writing unit 252 carries out LD (i.e., laser diodes) current control (or PWM (i.e., pulse width modulation) control) based on the image data, and drives respective LDs.

The engine control unit 510 mainly carries out control of image forming, and includes a CPU 511, the IPP 510-1 which carries out image processing, a ROM 510-2 which stores programs used for control of copying and printing out, a SRAM 510-3 and a NV-RAM 512 both being used for the control of copying and printing out. The NV-RAM 512 includes a SRAM (not depicted) and an EPROM (not depicted) which stores data after power supply turning off is detected. An I/O ASIC 510-4 includes a serial interface used for communicating with other CPUs in the image forming apparatus MF1, includes an engine control board, and controls I/Os with various parts/components provided nearby, i.e., counters, fans, solenoids, motors and so forth (not depicted). The engine control unit 510 and an I/O control unit 513 are connected via a synchronous serial interface. The CPU 511 may act as the CPU 1 depicted in FIG. 3, i.e., the memory reading and writing apparatus in an embodiment.

The I/O control unit 513 includes a CPU 517 which carries out control of signal/data input to and output from sensors and loads and control of the power supply unit 514 according to control instructions from the engine control unit 510, and programs and data stored in a ROM 518 and an NV-RAM (i.e., a nonvolatile RAM) 520. The I/O control unit 513 includes the ROM 518 storing the programs for causing the CPU 517 to carry out various operations, a RAM 519 used as a working memory of the CPU 517, the NV-RAM 520 which stores a power consumption table storing power consumption data for an operating state of each load or each operating mode of each load, a printing processing time table which stores time data required for printing processing for each operating mode and so forth, and an interface 515 which inputs and reads from various sensors 516 of the image forming apparatus MF1 and drives various loads.

The I/O control unit 513 carries out I/O control of the image forming apparatus MF1 including analog control of a P sensor, a T sensor (not depicted) and so forth, jam detection by reading a detection signal from a paper sensor (not depicted) and paper conveyance control according to given instructions, along with process control of image reading, printing, copying and so forth carried out by the engine control unit 510, and operates various actuators such as motors, clutches, solenoids, and so forth, sequentially depending on each operating mode.

The power supply unit 514 supplies power to control the image forming apparatus MF1. As a result of a main switch MAIN SW being turned on, commercial power is supplied. From the commercial power, a commercial alternative current power is supplied to an AC control circuit 540. AC controlled power which has been controlled, i.e., rectified, smoothed, and so forth, by the AC control circuit 540, is used by a DC power supply unit 514 which supplies necessary DC (Direct Current) voltages to respective control substrates. With the use of a constant voltage generated by the DC power supply unit 514, the CPU of each control substrate operates. The AC control circuit 540 includes an alternate current supply circuit (i.e., a heater driver, not depicted) which controls power supply to a heater (not depicted) of the fixing unit 214 to keep a fixing temperature constant. When the main switch MAIN SW is turned on, the AC control circuit 540 supplies commercial power to the heater driver, and also, supplies a direct current voltage to the DC power supply unit 514. Thus, the image forming apparatus MF1 enters a standby mode. When an instruction for copying or printing is given in this state, the system controller 501 directs the engine control unit 510 to carry out copying or printing, and the engine control unit 510 starts copying or printing accordingly. During the engine control unit 510 carrying out copying or printing, the image forming apparatus MF1 is in an operation mode, and power consumption is large accordingly.

When a predetermined time, input to the operating board 10, has elapsed during the standby mode which waits for a user's instruction, the system controller 501 switches the DC power supply unit 514 into an energy saving mode. That is, the AC control circuit 540 stops AC power supply to the heater driver, and the DC power supply unit 514 stops DC power supply circuits (not depicted) from a DC power receiving line (not depicted) except a standby power supply circuit which supplies a voltage for a recognition operation to a return electric circuit which carries out power supply control for returning to the operation mode when recognizing a direct access to the image forming apparatus MF1 by a user, i.e., an input to the operating board 10 or an actual operation by the user for copying or printing, or an image request or a printing request from the outside (personal computer or a facsimile machine). As a result, an operating voltage of the system controller 501 is lost. When recognizing a user's operation or an external access during the energy saving mode, the return electric circuit causes the AC control circuit 540 and the DC power supply unit 514 to enter the standby mode. Thereby, an operating voltage is applied to the system controller 501.

The operating board 10 has the liquid crystal touch panel, a ten-key, a clear/stop key, a start key, an initial setting key, a mode switching key, a test printing key, and a power supply key (not depicted). To the left side of the liquid crystal touch panel, an alphabet keyboard with hiragana (not depicted) is provided for inputting a URL, a mail sentence, a file name, a folder name, a setting, and for abbreviated dialing registration.

On the liquid crystal touch panel, various function keys, messages indicating operation states of the printer 300 and the system controller 501 and so forth are displayed. That is, on the liquid crystal touch panel, function selecting keys for selecting and indicating on-execution states of “copy” function, “scanner” function, “printing” function, “facsimile” function, “storage” function, “editing” function, “registration” function and so forth, are displayed. Also, on the liquid crystal touch panel, a page for inputting and outputting which is prepared for a selected function is displayed. For example, during the “copy” function being selected, function keys and messages indicating the number of copies and a state of the image forming apparatus MF1 are displayed. When a user touches a key displayed on the liquid crystal touch panel, the operating board 10 reads the user's input, and displays a selected key in gray in an inverted manner indicating that the key is thus selected. Further, when a user designates details of the function (for example, a type of page printing or such), a detail function setting page pops up as a result of the key being touched. The liquid crystal touch panel uses a dot indicator, and thus, it is possible to carry out a graphical display of optimal indication. The function keys include printing color designation keys, “black (Bk)”, “full-color”, “automatic color selection”, “blue (C)”, “red (M)” and “yellow (Y)”.

Connection and configuration concerning data reading and writing between the CPU 511 and the NV-RAM 512 in the engine control unit 510, as an embodiment, are the same as the connection and the configuration depicted in FIG. 3. That is, the CPU 511 has the same configuration as a configuration of the CPU 1 depicted in FIG. 3, and the NV-RAM 512 has the same configuration as a configuration of the storage unit 2 depicted in FIG. 3, at least concerning data reading and writing operations.

Transmission control carried out when the CPU 511 writes data in the NV-RAM 512 is the same as transmission control carried out by the main control unit 105 depicted in FIG. 3 described above with reference to FIGS. 4A and 4B and FIGS. 7A and 7B. However, a sequence in which the CPU 511 reads data stored in the NV-RAM 512 is a sequence which will be described below with reference to FIGS. 5A, 5B and FIGS. 6A, 6B and 6C, which is different from the sequence described above with reference to FIGS. 8A, 8B and 8C.

FIGS. 5A and 5B depict the contents of reception control by the main control unit 105 which is included in the CPU 511 in the case where the CPU 511 acts as the CPU 1, carried out when the CPU 511 reads data from the NV-RAM 512. With reference to FIGS. 5A, 5B and FIGS. 6A, 6B and 6C, an operation sequence of the main control unit 105 in the CPU 511 for when the CPU 511 reads data from the NV-RAM 512 will now be described.

First, the main control unit 105 of the CPU 511 (depicted in FIG. 3) sets dummy data as the top two bits of a first byte 131 in the transmission register 109 in the CPU 511. That is, as depicted in FIG. 6A, “0” is stored in each of DO7 and DO6. That is, the number of bits of dummy data is 3 in FIG. 8A, but is 2 in FIG. 6A in an embodiment. Next, a start bit “1” is set in DO5, “C1” is set in DO4, “C0” is set in DO3, “A9” is set in DO2, “A8” is set in DO1, and “A7” is set in DO0 (step S21 in FIG. 5A). Then, the first byte is transmitted to the NV-RAM 512 (depicted in FIG. 3 as the storage unit 2), as a CPU_DATA_OUT signal in synchronization with each decaying edge of the SYNC_CLK signal (steps S22 and S24). At the same time of the start of data transmission, the main control unit 105 of the CPU 511 takes a CPU_DATA_IN signal received from the NV-RAM 512 in synchronization with each rising edge of the SYNC_CLK signal and stores the thus-received data in the reception register 110 of the CPU 511 (step S23).

Until receiving address data A0, the NV-RAM 512 transmits “1” as the CPU_DATA_IN signal, and the “1” is stored in the reception register 110, in each of respective bit storage positions DI7 through DI0. That is, as depicted in FIG. 6B, all the bits of a first byte 134 in the reception register 110 are “1”. Data “1” thus stored in the reception register 110 are cleared (step S25).

Next, the main control unit 105 in the CPU 511 stores in the transmission register 109 in the CPU 511 as a second byte 132 depicted in FIG. 6A, “A6” in the bit storage position DO7, “A5” in the bit storage position DO6, “A4” in the bit storage position DO5, “A3” in the bit storage position DO4, “A2” in the bit storage position DO3, “A1” in the bit storage position DO2, “A0” in the bit storage position DO1, and “0” in the bit storage position DO0 as one bit of dummy data (step S26) The second byte 132 of data is then transmitted to the NV-RAM 512 as the CPU_DATA_OUT signal in synchronization with each decaying edge of the SYNC_CLK signal (steps S27 and S29). At the same time of the start of data transmission, the main control unit 105 of the CPU 511 takes the CPU_DATA_IN signal received from the NV-RAM 512 in synchronization with each rising edge of the SYNC_CLK signal and stores the thus-received data in the reception register 110 of the CPU 511 (step S27 and S28).

Of a received second byte 135 of data stored in the reception register 110 depicted in FIG. 6B, “1” is stored in each of the bit storage positions DI7 through DI1, before the NR-RAM 512 detects “A0” transmitted by the CPU 511 in step S27. That is, before the fifteenth (“15” in FIG. 6C) rising edge of the SYNC_CLK signal with which the NV-RAM 512 takes “A0”, the NV-RAM 512 outputs “1”. With the fifteenth rising edge of the SYNC_CLK signal, the NV-RAM 512 recognizes “A0” which is the last bit of the address data bits A9 through A0 and indicates the end of the address transmitted by the CPU 511, and, in response, outputs an A0 recognition bit “0” (i.e., A0 RECOGNITION BIT=“0” in FIG. 6C) in the CPU_DATA_IN signal. The CPU 511 detects the A0 recognition bit “0” with a sixteenth rising edge of the SYNC_CLK signal (Yes in step S30). Thereby, as depicted in FIG. 6B, the A0 recognition bit “0” is stored in the bit storage position DI0 of the second byte of the reception register 110. After thus outputting the A0 recognition bit “0”, i.e., from the sixteenth rising edge of the SYNC_CLK signal, the NV-RAM 512 outputs a byte of data D7 through D0 stored at an address of the data storage area 119 in the NV-RAM 512 designated by the address data bits A9 through A0 transmitted by the CPU 511. After the CPU 511 takes the A0 recognition bit “0” from the CPU_DATA_IN signal with the sixteenth rising edge of the SYNC_CLK signal, D7 is stored in DI7, D6 is stored in DI6, D5 is stored in DI5, D4 is stored in DI4, D3 is stored in DI3, D2 is stored in DI2, D1 is stored in DI1, and D0 is stored in DI0, as a third byte of data 136 depicted in FIG. 6B (steps S33, S34, S35). As depicted in FIG. 6B, the third byte of data 136 which is stored in the reception register 110 of the CPU 511 at one time corresponds to the byte of data output by the NV-RAM 512 from the designated address in a one-to-one manner. That is, bit disagreement is avoided. This is because the two bits of dummy data are stored in DO7 and DO6 in the first byte 131 in the transmission register 109 at the first time as depicted in FIG. 6A, the one bit of dummy data is stored in DO0 subsequent to A0 in DO1 in the second byte 132 in the transmission register 109 at the second time as depicted in FIG. 6A, and the first and second bytes 131, 132 are output to the NV-RAM 512 in the CPU_DATA_OUT signal. It is noted that, when the CPU 511 does not detect the A0 recognition bit “0” (No in step S30), the CPU 511 determines that a communication error has occurred, and stops the communication.

Data reading and writing carried out by each of the CPU 502 in the system controller 501 and the CPU 517 in the I/O control unit 502 from/to a respective one of the NV-RAM 503 and the NV-RAM 520 is identical to data reading and writing carried out by the CPU 511 from/to the NV-RAM 512 of the engine control unit 510 described above with reference to FIG. 3, FIGS. 4A, 4B, FIGS. 5A, 5B, FIGS. 6A, 6B and 6C and FIGS. 7A and 7B. It is noted that, in a case where the more significant two bits A9, A8 of the address data A9 through A0 are used to designate a memory or another device by the CPU 511, 502 or 517, the maximum possible number of memories and other devices is 4 (=2²). Therefore, in an embodiment in which the maximum possible number of memories and other devices is more than 4, address data may include 11 bits, i.e., A10 through A0. In this case, in consideration of the number of bits of address data thus increasing by one, in the first byte of data set in the transmission register 109, i.e., each of 120 and 131 depicted in FIG. 7A and FIG. 6A, the number of the top dummy data is reduced by one from the above-mentioned number (3 in the first byte of data 120 and 2 in the first byte of data 131). Thus, the number of top dummy data is 2 in the first byte of data 120 and 1 in the first byte of data 131 in this case. The other function configuration and operation sequence of memory reading and writing carried out by the CPU 511, 502 or 517 are the same as the function configuration and operation sequence described above with reference to FIG. 3, FIGS. 4A, 4B, FIGS. 5A, 5B, FIGS. 6A, 6B and 6C and FIGS. 7A and 7B.

The present invention is not limited to the specifically disclosed embodiments, and variations and modifications may be made without departing from the scope of the present invention.

The present application is based on Japanese priority applications Nos. 2008-177018 and 2009-150820, filed Jul. 7, 2008 and Jun. 25, 2009, respectively, the entire contents of which are hereby incorporated herein by reference.

What is claimed is:

1. A memory reading and writing apparatus comprising:
a transmission register of B bits and a reception register of B bits, wherein a storage unit notifies the memory reading and writing apparatus of address reception completion when completing reception of address data, and has a number B of bits by which data are written and read in/from the storage unit for each address;
a transmission port used for transmitting data of the transmission register to the storage unit in series;
a reception port used for receiving data output by the storage unit in series, thus-received data being stored in the reception register;
a synchronization clock signal output port used to output a synchronization clock signal used for transmitting and receiving serial data to/from the storage unit with the use of the transmission port and the reception port, respectively; and
a control part configured to dispose dummy bits, a number of which dummy bits is a first number, a start bit, control code bits and address data bits in the stated order in series, create B×n bits of data, where n denotes an integer equal to or more than 1, store the data in the transmission register for each B bits from a top of the B×n bits, transmit the data to the storage unit via the transmission port in series for each B bits together with the synchronization clock signal, subsequently store B bits of transmission data in the transmission register, transmit the B bits of transmission data via the transmission port together with the synchronization clock signal in series, and write the transmission data in the storage unit, wherein:
the control part disposes dummy bits, a number of which dummy bits is smaller by one than the first number, a start bit, control code bits, address data bits and one dummy bit in the stated order in series, creates B×n bits of data, where n denotes an integer equal to or more than 1, stores the data in the transmission register for each B bits from a top of the B×n bits, transmits the data to the storage unit via the transmission port in series for each B bits together with the synchronization clock signal, stores a signal in the reception register as a group of B bits in synchronization with the synchronization clock signal, the signal being given by the storage unit to the reception port in response to the data transmitted to the storage unit, processes a group of B bits of the signal as data read from the storage unit after a last bit of a group of B bits of the signal stored in the reception register indicates address reception completion, and reads the data from the storage unit.

2. The memory reading and writing apparatus as claimed in claim 1, wherein:
the transmission data has a width of 8 bits, and the data transmitted before transmitting the transmission data includes three dummy bits, one start bit, two control code bits and ten address data bits, in the stated order, and
data received from the storage unit has a width of 8 bits, and the data transmitted for reading data from the storage unit includes two dummy bits, one start bit, two control code bits, ten address data bits and one dummy bit, in the stated order.

3. An image forming apparatus comprising:
an image forming part configured to form an image represented by image data on paper;
an engine control part configured to control image formation of the image forming part;
an I/O control part configured to control input and output of sensors and loads of the image forming part, according to control instructions provided by the engine control part, and wherein:
the engine control part comprises a program memory, the storage unit which notifies the memory reading and writing apparatus of address reception completion when completing reception of address data, and the memory reading and writing apparatus claimed in claim 1 which writes and reads data in/from the storage unit, and controls image formation in the image forming part by providing control instructions to the I/O control part according to programs and data stored in the program memory and the storage unit.

4. An image forming apparatus comprising:
an image forming part configured to form an image represented by image data on paper;
an engine control part configured to control image formation of the image forming part; and
a system controller configured to direct the engine control part to carry out image formation according to image forming conditions designated by a user, and inputs and outputs image data from/to the engine control part, and wherein:
the system controller comprises a program memory, the storage unit which notifies the memory reading and writing apparatus of address reception completion when completing reception of address data, and the memory reading and writing apparatus claimed in claim 1 which writes and reads data in/from the storage unit, and transmits and receives image data to/from the engine control part according to image processing instructions given via communication, and programs and data stored in the program memory and the storage unit.

5. An image forming apparatus comprising:
an image forming part configured to form an image represented by image data on paper;
an engine control part configured to control image formation of the image forming part; and
an I/O control part configured to control input and output of sensors and loads of the image forming part, according to control instructions provided by the engine control part, and wherein:
the I/O control part comprises a program memory, the storage unit which notifies the memory reading and writing apparatus of address reception completion when completing reception of address data, and the memory reading and writing apparatus claimed in claim 1 which writes and reads data in/from the storage unit, and controls input and output of sensors and loads of the image forming part according to control instructions given by the engine control part, and programs and data stored in the program memory and the storage unit.

6. A memory reading and writing apparatus comprising:
a transmission register configured to store a number of bits, and a reception register configured to store the same number of bits, the number being the same as a number of bits by which data are written and read in/from a storage unit for one address, the storage unit notifying the memory reading and writing apparatus of address reception completion when completing reception of address data;
a transmission port used to transmit data of the transmission register to the storage unit in series;
a reception port used to receive data output by the storage unit in series, thus-received data being stored in the reception register;
a synchronization clock signal output port used to output a synchronization clock signal used for transmitting and receiving serial data to/from the storage unit with the use of the transmission port and the reception port, respectively; and
a control part configured to dispose dummy bits, a number of which dummy bits is a first number, a start bit, control code bits and address data bits in the stated order in series, create two bytes of data, store the data in the transmission register for each byte of bit group from a top of the two bytes of data, transmit the data to the storage unit via the transmission port in series for the byte of bit group together with the synchronization clock signal, subsequently store a byte of transmission data in the transmission register, transmit the byte of transmission data via the transmission port together with the synchronization clock signal in series, and write the transmission data in the storage unit, and wherein:
the control part disposes dummy bits, a number of which dummy bits is smaller by one than the first number, a start bit, control code bits, address data bits and one dummy bit in the stated order in series, creates two bytes of data, stores the data in the transmission register for each byte of bit group from a top of the two byte of data, transmits the data to the storage unit via the transmission port in series for the byte of bit group together with the synchronization clock signal, stores a signal in the reception register as a byte of bit group in synchronization with the synchronization clock signal, the signal being given by the storage unit to the reception port in response to the data transmitted to the storage unit, processes a byte of a bit group of the signal as data read from the storage unit after a last bit of a byte of a bit group of the signal stored in the reception register indicates address reception completion, and reads the data from the storage unit.

7. The memory reading and writing apparatus as claimed in claim 6, wherein:
the transmission data have a width of 8 bits, and the data transmitted before transmitting the transmission data includes three dummy bits, one start bit, two control code bits and ten address data bits, in the stated order, and
data received from the storage unit have a width of 8 bits, and the data transmitted for reading data from the storage unit includes two dummy bits, one start bit, two control code bits, ten address data bits and one dummy bit, in the stated order.

8. An image forming apparatus comprising:
an image forming part configured to form an image represented by image data on paper;
an engine control part configured to control image formation of the image forming part; and
an I/O control part configured to control input and output of sensors and loads of the image forming part, according to control instructions provided by the engine control part, and wherein:
the engine control part comprises a program memory, the storage unit which notifies the memory reading and writing apparatus of address reception completion when completing reception of address data, and the memory reading and writing apparatus claimed in claim 6 which writes and reads data in/from the storage unit, and controls image formation in the image forming part by providing control instructions to the I/O control part according to programs and data stored in the program memory and the storage unit.

9. An image forming apparatus comprising:
an image forming part configured to form an image represented by image data on paper;
an engine control part configured to control image formation of the image forming part; and
a system controller configured to direct the engine control part to carry out image formation according to image forming conditions designated by a user, and inputs and outputs image data from/to the engine control part, and wherein:
the system controller comprises a program memory, the storage unit which notifies the memory reading and writing apparatus of address reception completion when completing reception of address data, and the memory reading and writing apparatus claimed in claim 6 which writes and reads data in/from the storage unit, and transmits and receives image data to/from the engine control part according to image processing instructions given via communication, and programs and data stored in the program memory and the storage unit.

10. An image forming apparatus comprising:
an image forming part configured to form an image represented by image data on paper;
an engine control part configured to control image formation of the image forming part; and
an I/O control part configured to control input and output of sensors and loads of the image forming part, according to control instructions provided by the engine control part, and wherein:
the I/O control part comprises a program memory, the storage unit which notifies the memory reading and writing apparatus of address reception completion when completing reception of address data, and the memory reading and writing apparatus claimed in claim 6 which writes and reads data in/from the storage unit, and controls input and output of sensors and loads of the image forming part according to control instructions given by the engine control part, and programs and data stored in the program memory and the storage unit.
